(19) United States
(12) Patent Application Publication
(10) Pub. No.: US 2012/0296962 A1
(43) Pub. Date: Nov. 22, 2012

(54) MEDICAL IMAGE PROCESSING SYSTEM AND A MEDICAL IMAGE PROCESSING SERVER

(75) Inventor: Hideki Tada, Nasushiobara-shi (JP)

(73) Assignees: Toshiba Medical Systems Corporation, Otawara-shi, Tochigi (JP); Kabushiki Kaisha Toshiba, Tokyo (JP)

(21) Appl. No.: 13/519,334

(22) PCT Filed: Nov. 15, 2011
(86) PCT No.: PCT/JP2011/076225

§ 371 Date: Jun. 27, 2012

(30) Foreign Application Priority Data
Nov. 24, 2010 (JP) 2010-260956

(51) Int. Cl. G06F 15/16

(52) U.S. Cl. 709/203

(57) ABSTRACT

In case of communication is interrupted as a result of unforeseen circumstances, it is intended to allow confirming the results of processing executed while communication is interrupted. The medical image processing system includes a server comprising a processor and a screen generator. The processor executes an application for generating and editing a medical image based on instructions from a client. The screen generator generates and delivers the screen to the client upon receiving the processing results of the application. The server comprises a disconnect detector, a screen storage, and a screen storage controller. The disconnect detector detects communication interruption with the client. The screen storage controller causes the screen storage to store the screen generated in a first period from the time when the disconnect detector detects an interruption of communication. A screen playback part delivers the screen stored in the screen storage to the client.

### FIELD

Embodiments of the present invention relate to central control of processing medical data including medical image data, etc., by a server.

### BACKGROUND ART

Thin client systems, in which a client makes a request for processing to a server through a network and displays results processed by the server, have been introduced as medical image processing systems. These types of thin client systems may be configured as systems on a client terminal without providing storages such as hard disks.

The introduction of these types of medical image processing systems has allowed the server to execute processing conventionally executed at the client. Consequently, it has become possible to process processing with larger loads such as image processing on a high performance server, so that the client can confirm the processing results. Moreover, data and software are centrally managed on the server, making it possible to improve the efficiency of maintenance work.

Moreover, with these types of medical image processing systems, processing is executed on the server side; therefore, even if communication between the client and the server is interrupted, it is possible to continue processing on the server side. Consequently, with these types of medical image processing systems, even if the network is disconnected while real time processing and/or background processing are running, processing is continuously executed on the server. However, if communication between the client and the server is interrupted as a result of unforeseen circumstances, the results of processing executed on the server side cannot be delivered while communication is interrupted. Therefore, it was impossible to confirm the results of processing executed while communication was interrupted.

### PRIOR ART DOCUMENTS

### Patent Documents

[Patent Document 1] Japanese published unexamined application 2010-097323

### SUMMARY

### Problems to be Solved by the Invention

Embodiments of the present invention are intended to solve the above problems, with the object of providing a medical image processing system that makes it possible to confirm the results of processing executed while communication is interrupted even if communication has been interrupted as a result of unforeseen circumstances.

### Means for Solving the Problems

This embodiment is a medical image processing system that includes a server and comprises a processor and a screen generator in order to achieve the above object. The processor executes an application that generates or edits medical images based on instructions from a client. The screen generator generates a screen upon receiving the processing results of the application and delivers the generated screen to the client. Moreover, the server comprises a disconnect detector, a screen storage, a screen storage controller, and a screen playback part. The disconnect detector detects when communication with the client has been interrupted. The screen storage controller stores the screen generated in a predefined first period in the screen storage based on the timing in which the disconnect detector detects interruption of communication with the client. The screen playback part delivers the screen stored in the screen storage to the client.

Moreover, a second form of this embodiment is a medical image processing server comprising a processor and a screen generator. The processor executes an application that generates or edits medical images based on instructions from a client. The screen generator generates a screen upon receiving the processing results of the application and delivers the generated screen to the client. Moreover, the medical image processing server comprises a disconnect detector, a screen storage, a screen storage controller, and a screen playback part. The disconnect detector detects when communication with the client has been interrupted. The screen storage controller stores the screen generated in a predefined first period in the screen storage based on the timing in which the disconnect detector detects interruption of communication with the client. The screen playback part delivers the screen stored in the screen storage to the client.

Moreover, a third form of this embodiment is a medical image processing system that includes a server and comprises a processor and a screen generator. The processor executes an application that generates or edits medical images based on instructions from a client. The screen generator generates a screen upon receiving the processing results of the application and delivers the generated screen to the client. Moreover, the server comprises a disconnect detector, a screen storage, a screen storage controller, and a screen playback part. The disconnect detector detects when communication with the client has been interrupted. The screen storage controller stores the generated screen in the screen storage. The login detection part detects that an operator has logged into the server by means of an operation from the client. The screen playback part delivers the screen stored in the screen storage to the client when the login detection part detects the login after interruption of communication.

### BRIEF DESCRIPTION OF THE DRAWINGS

FIG. 1 is a block diagram of the medical image processing system according to the first and second embodiments.

FIG. 2 is a flow chart showing the flow of processing regarding detection of interruption of communication and storage of a screen for the medical image processing system according to the first embodiment.

FIG. 3 is a flow chart showing the action at the time of login for the medical image processing system according to the first and second embodiments.

FIG. 4 is a flow chart showing the flow of processing regarding detection of interruption of communication and storage of a screen for the medical image processing system according to the second embodiment.

FIG. 5 is a block diagram of the medical image processing system according to the third and fourth embodiments.

FIG. 6 is a flow chart showing the flow of processing regarding detection of interruption of communication and storage of a screen for the medical image processing system according to the third and fourth embodiments.

FIG. 7 is a flow chart showing the flow of processing regarding storage of control information for the medical image processing system according to the third embodiment.

FIG. 8 is a flow chart showing the action at the time of login for the medical image processing system according to the third and the fourth embodiments.

FIG. 9 is a flow chart showing the flow of processing regarding reconfiguration of the operating environment for the medical image processing system according to the third embodiment.

FIG. 10 is a flow chart showing the flow of processing regarding storage of control information for the medical image processing system according to the fourth embodiment.

FIG. 11 is a flow chart showing the flow of processing regarding reconfiguration of the operating environment for the medical image processing system according to the fourth embodiment.

### MODES FOR CARRYING OUT THE INVENTION

### First Embodiment

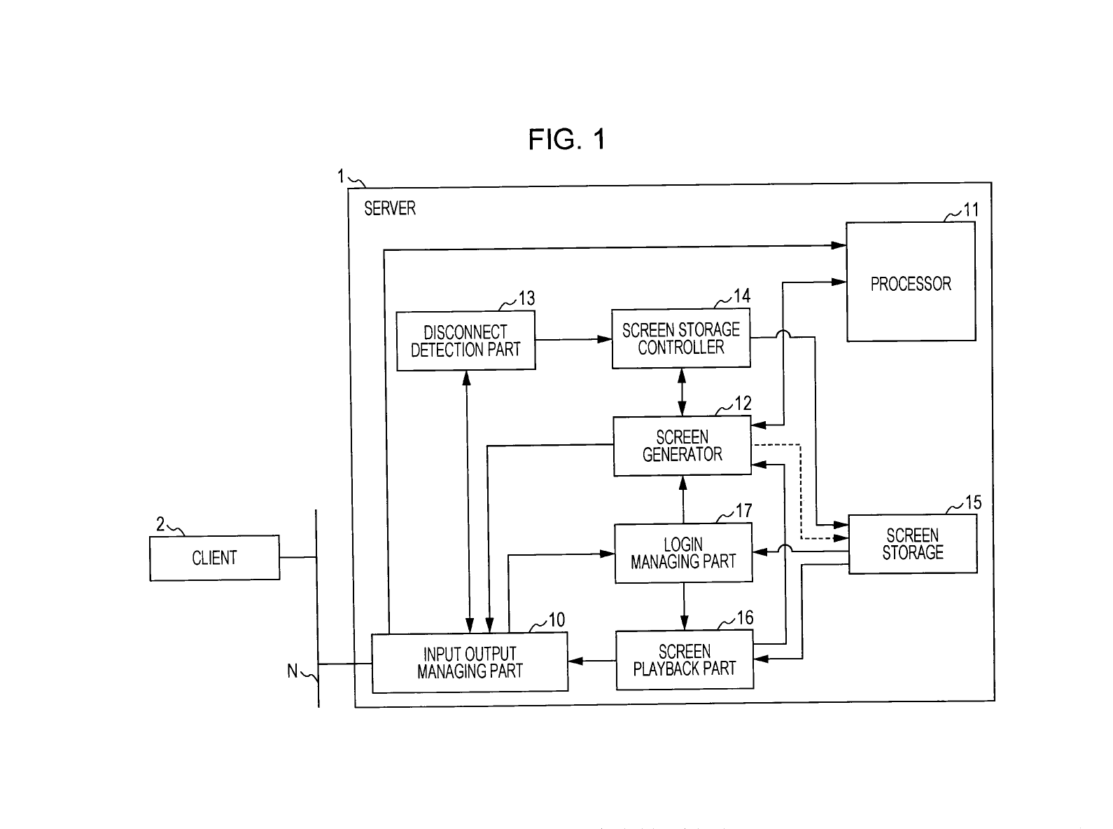

The units configuring the medical image processing system according to the first embodiment is set forth with reference to FIG. 1. The medical image processing system according to the present embodiment is a thin client system comprising a server 1 and a client 2.

The server 1 comprises an input output managing part 10, a processor 11, a screen generator 12, a disconnect detection part 13, a screen storage controller 14, a screen storage 15, a screen playback part 16, and a login managing part 17.

The input output managing part 10 transmits and receives various data with the client 2 through a network N. The input output managing part 10 outputs various requests received from the client 2 through the network N to the corresponding configuration inside the server 1. Moreover, the input output managing part 10 delivers data received from each configuration inside the server 1 to the client 2 through the network N. Note that hereinafter, description of transmitting and/or receiving data by each configuration inside the server 1 with the client 2 means that transmission and reception of data are carried out through this input output managing part 10 and the network N.

The disconnect detection part 13 monitors the communication state (the network N) between the client 2 and the server 1 and detects if communication is interrupted. For example, the disconnect detection part 13 regularly confirms the presence of a response with the client 2 as the method of this detection, and if there is no response, it is possible to recognize that communication with the client 2 has been interrupted. Note that the monitoring method of the network N by means of the disconnect detection part 13 is not limited to the above example, and a method may be replaced as appropriately that allows detecting interruption of communication between the client 2 and the server 1. In response to detection of communication interruption, the disconnect detection part 13 notifies the screen storage controller 14 of the communication interruption. Note that the screen storage controller 14 will be subsequently set forth.

Upon receiving a processing request from the client 2, the processor 11 generates, edits, and displays a medical image according to the request. A specific example of the processor 11 includes various applications that display or edit medical images upon receiving the medical image from modality or medical image storage provided outside the server 1. The processor 11 outputs the processing results of the medical image to the screen generator 12, allowing the screen generator 12 to generate a screen on which the processing results of the processor 11 are displayed and deliver it to the client 2. The screen generator 12 will be subsequently set forth in detail. Note that the processor 11 may include the modality or a configuration to generate the medical image. Moreover, the explanation was provided above with reference to processing of the medical image as an example; however, the processor 11 may include an application that executes other processing.

The screen generator 12 creates an operation screen for executing various processing by means of the processor 11 upon receiving notification from the login managing part 17 that an operator has logged into the server 1 by means of an operation from the client 2. The login managing part 17 will be subsequently set forth. Here, the operation screen that the screen generator 12 generates is data for displaying the operation screen on a display (not shown in the figures) of the client 2. Here, an explanation is provided regarding the operation screen that the screen generator 12 delivers, with reference to a specific example. The screen generator 12 may be configured so as to deliver to the client 2 control data that causes the client 2 to display the operation screen on the display. In this case, the client 2 generates the operation screen based on this received control data and causes the display to display it. Moreover, the screen generator 12 may be configured so as to deliver the operation screen to the client 2 as image data. In this case, the client 2 may display the delivered image data on the display. Note that, hereinafter, this data according to the display of the operation screen may simply be referred to as “screen.”

The screen generator 12 delivers the created screen to the client 2. The screen generator 12 generates and successively delivers this screen to the client 2. Moreover, upon receiving the processing results from the processor 11, it reflects the processing results on the operation screen and subsequently delivers it to the client 2. The client 2 displays the delivered screen on the display. Accordingly, by operating the operation screen displayed on the display of the client 2, the operator is able to request processing to the processor 11 through the network N and confirm the results of processing.

Moreover, upon being instructed by the screen storage controller 14 to output the screen, the screen generator 12 successively outputs the generated screen to the screen storage controller 14. An explanation will be provided subsequently regarding the screen storage controller 14. Upon receiving instructions from the screen storage controller 14, the screen generator 12 stops the output of the screen to this screen storage controller 14. Note that the screen generator 12 may be configured such that if it receives notification from the login managing part 17 that the operator has logged in while the screen is being output to the screen storage controller 14, it stops the output of the screen to the screen storage controller 14. In this case, the screen generator 12 may notify the screen storage controller 14 that the output of the screen is stopped by means of the login by the operator. Moreover, the screen generator 12 may be configured such that if communication is interrupted as a result of the network disconnect and the screen cannot be delivered to the client 2, it stops delivering the screen to the client 2. Moreover, the screen generator 12 may be configured such that it stops delivering the screen to the client 2 upon receiving instructions from the screen storage controller 14.

After receiving the screen generated by means of the screen generator 12 from the screen storage controller 14, the screen storage 15 stores this screen so as to be obtainable.

The screen storage controller 14 receives notification from the disconnect detection part 13 that communication with the client 2 has been interrupted. Upon receiving this notification, the screen storage controller 14 instructs the screen generator 12 to output the screen. Upon receiving the screen that is successively output from the screen generator 12, the screen storage controller 14 stores this screen in the screen storage 15. This output of the screen by means of the screen generator 12 is stopped if the operator logs in. Note that in this case, “a period after the screen generator 12 starts the output until the operator logs in” corresponds to a “first period.”

Moreover, the screen storage controller 14 may be configured to instruct the screen generator 12 to stop the output of the screen if a predetermined period elapses. When this instruction is received, the screen generator 12 stops the output of the screen to the screen storage controller 14. By having the above configuration, for example, an action of “storing in the screen storage 15 screens generated within 30 minutes after communication with the client 2 has been interrupted” becomes possible. Accordingly, it is possible to limit the amount of data of the screen stored in the screen storage 15 and prevent depletion of the screen storage 15. Note that in this case, the “predetermined period” corresponds to the “first period.”

Note that in the above explanation, the screen storage controller 14 stored the screen in the screen storage 15; however, it may be configured such that the screen generator 12 may store the screen in the screen storage 15. In this case, upon receiving notification from the disconnect detection part 13, the screen storage controller 14 instructs the screen generator 12 to store the screen in the screen storage 15. Upon receiving this instruction, the screen generator 12 successively stores the generated screen in the screen storage 15.

Upon receiving from the client 2 a login request to the server 1, the login managing part 17 carries out authentication to the server 1 based on an ID and password transmitted together. Authentication information such as this ID and password may be managed by providing a database, etc. If the login managing part 17 is successfully authenticated, it confirms whether or not the screen is stored in the screen storage 15. If the screen is stored in the screen storage 15, the login managing part 17 instructs the screen playback part 16 to play this screen. An explanation will be provided subsequently regarding the screen playback part 16. Moreover, if the screen is not stored in the screen storage 15, it instructs the screen generator 12 to start generating the screen. Accordingly, the operation screen is displayed at the client 2.

The screen playback part 16 receives instructions from the login managing part 17 regarding playback of the screen. Upon receiving these instructions, the screen playback part 16 reads the screen stored in the screen storage 15. The screen playback part 16 delivers the read out screen to the client 2. Specifically, for example, the screen playback part 16 plays the read out screen as a movie according to the time series in which these screens are stored and delivers this movie to the client 2. Moreover, the screen playback part 16 may be run such that the read screen is successively delivered to the client 2 according to the time series. Accordingly, it is possible for the operator to confirm the screen generated while communication is interrupted.

Note that if instructions are received from the login managing part 17, the screen playback part 16 may generate a dialog for asking the operator whether or not to play the screen, delivering it to the client 2. In this case, if the screen playback part 16 is instructed to play the screen by the operator, it may read the screen stored in the screen storage 15 and deliver it to the client 2. Note that the screen playback part 16 may be run such that after processing regarding the delivery of the screen stored in the screen storage 15 is completed, it notifies the screen generator 12 of completion of this processing. Accordingly, after delivery of the screen stored in the screen storage 15, it is possible for the screen generator 12 to start generating and delivering the operation screen. Moreover, for the screen playback part 16, if the screen is stored in the screen storage 15, that is, as long as the interrupted communication is resumed afterwards, the timing to deliver the screen is not limited. For example, it may be configured such that the operator operates the client 2 at the predefined timing after re-login and causes the screen playback part 16 to deliver these screens.

(Series of Actions)

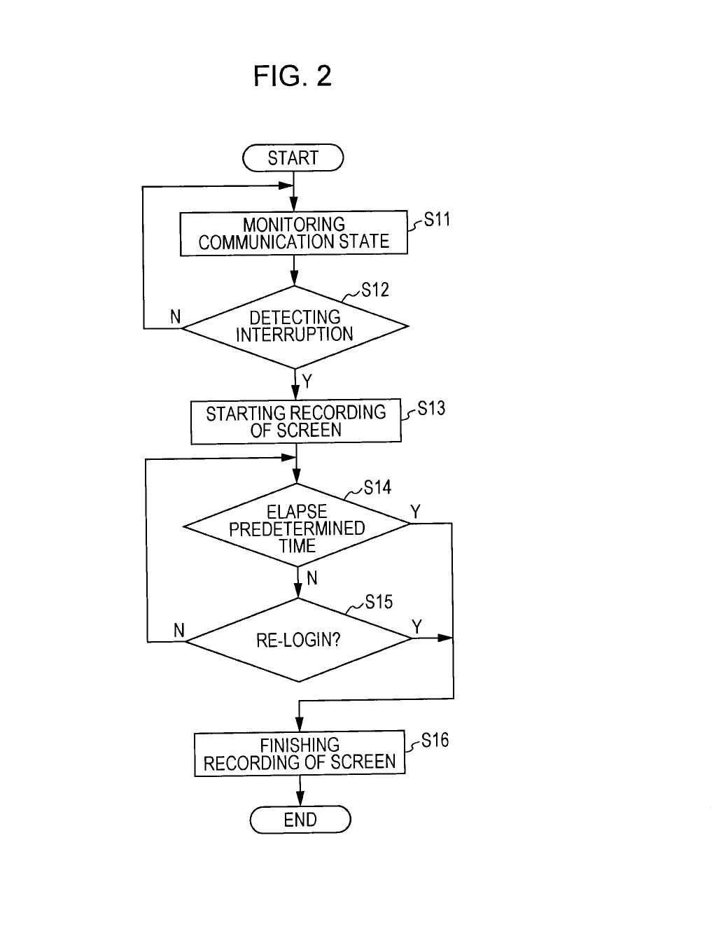

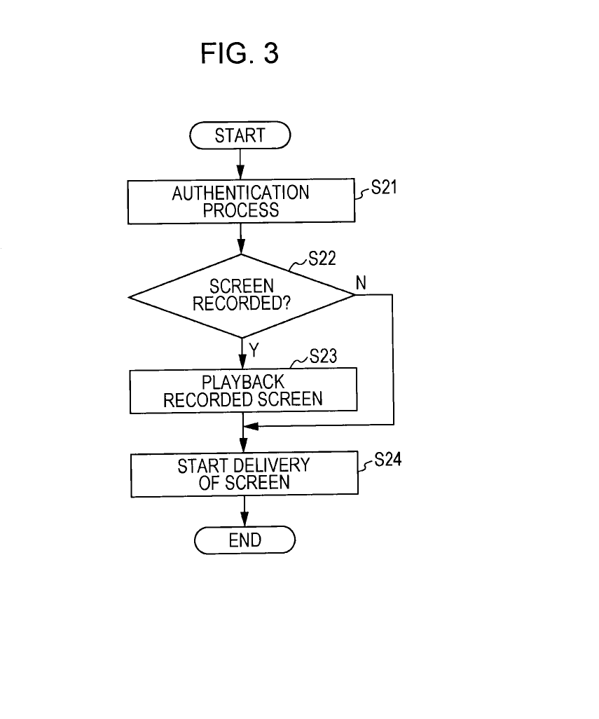

Next, an explanation is provided regarding the series of actions of the medical image processing system according to the present embodiment, with reference to FIG. 2 and FIG. 3. FIG. 2 is a flow chart showing the flow of processing regarding detection of the interruption of communication and storage of the screen to the screen storage 15 for the medical image processing system according to the first embodiment. FIG. 3 is a flow chart showing the action at the time of login for the medical image processing system according to the first and second embodiments. FIG. 2 is referenced first.

(Step S11, Step S12)

Communication is established between the client 2 and the server 1 as the operator logs into the server 1 by means of the operation from the client 2. Once communication is established, the screen generator 12 successively creates an operation screen and delivers this screen to the client 2. Moreover, the disconnect detection part 13 monitors the communication state between the client 2 and the server 1 and detects if communication is interrupted (Step S11). While the operator is logged into the server 1, the disconnect detection part 13 continues monitoring this communication state (Step S12, N). If the disconnect detection part 13 detects that communication has been interrupted (Step S12, Y), it notifies the screen storage controller 14 that communication has been interrupted.

(Step S13)

The screen storage controller 14 receives notification from the disconnect detection part 13 that communication with the client 2 has been interrupted. Upon receiving this notification, the screen storage controller 14 instructs the screen generator 12 to output the screen. Upon receiving this instruction, the screen generator 12 successively outputs the generated screen to the screen storage controller 14. Upon receiving the screen output from the screen generator 12 successively, the screen storage controller 14 stores this screen in the screen storage 15.

(Step S14, Step S16)

Upon receiving notification from the disconnect detection part 13, if the predetermined period elapses (Step S14, Y), the screen storage controller 14 instructs the screen generator 12 to stop the output of the screen (Step S16). Accordingly, the screen storage controller 14 stops storing the screen in the screen storage 15.

(Step S15, Step S16)

Moreover, even before the predetermined period elapses, if the login to the server 1 by the operator is detected again (Step S15, Y), the output of the screen by means of the screen generator 12 is stopped. Specifically, if the screen generator 12 receives notification from the login managing part 17 that the operator has logged in while the screen is being output to the screen storage controller 14, it stops the output of the screen to the screen storage controller 14 (Step S16). Accordingly, the screen storage controller 14 stops storing the screen in the screen storage 15.

(Step S14, Step S15)

Before the predetermined period elapses (Step S14, N) and while the re-login by the operator is not detected (Step S15, N), the screen storage controller 14 stores the screen output by the screen generator 12 in the screen storage 15.

Next, with reference to FIG. 3, an explanation is provided focusing on a series of actions at the time of login, particularly focusing on the action when communication is interrupted.

(Step S21)

Upon receiving from the client 2 the login request to the server 1, the login managing part 17 carries out authentication on the server 1 based on the ID and password transmitted together from the client 2.

(Step S22)

If authentication is successful, the login managing part 17 confirms whether or not the screen is stored in the screen storage 15.

(Step S23)

If the screen is stored in the screen storage 15 (Step S22, Y), the login managing part 17 instructs the screen playback part 16 the playback of this screen. Upon receiving these instructions, the screen playback part 16 reads the screen stored in the screen storage 15. The screen playback part 16 delivers the read out screen to the client 2. If the screen is not stored in the screen storage 15 (Step S22, N), processing moves on to the subsequent processing step without these processes being executed. After completion of processing regarding the delivery of the screen stored in the screen storage 15, the screen playback part 16 notifies the screen generator 12 of the completion of this processing.

(Step S24)

Next, the screen generator 12 starts creating the operation screen for executing various processing steps by means of the processor 11 and delivering the created screen to the client 2. Accordingly, the operator operates the client 2, making it possible to resume processing in the server 1.

As above, the medical image processing system according to the present embodiment stores the screen generated in the predefined period after the interruption of communication with the client in the screen storage, making it possible to play this screen at the time of re-login. Accordingly, even if the network is disconnected, it is possible to confirm the processing results output to the screen while communication is interrupted.

### Second Embodiment

The medical image processing system according to the first embodiment detects the interruption of communication with the client 2, allowing the screen generated after the interruption of communication to be confirmed. In contrast, the medical image processing system according to the second embodiment allows the screen generated before and after the interruption of communication to be confirmed. Therefore, the medical image processing system according to the present embodiment is different from the medical image processing system according to the first embodiment, in view of the action of the screen generator 12 and the screen storage controller 14. Hereinafter, the configuration and action of the medical image processing system according to the present embodiment are set forth focusing on differences with the first embodiment.

The screen generator 12 creates a screen and delivers this screen to the client 2. The screen generator 12 successively creates this screen and delivers it to the client 2. This is similar to the first embodiment. Furthermore, the screen generator 12 according to the present embodiment successively outputs the created screen to the screen storage controller 14. Upon receiving instructions from the screen storage controller 14, the screen generator 12 stops the output of the screen to the screen storage controller 14. Moreover, if the operator logs out from the server 1 based on the operation by the operator from the client 2, the screen generator 12 stops the output of the screen to this screen storage controller 14. Note that the screen generator 12 may be configured to stop the output of the screen to the screen storage controller 14, if notification of the operator login from the login managing part 17 is received during output of the screen to the screen storage controller 14. This is similar to the screen generator 12 according to the first embodiment. When the operator login causes the output of the screen to the screen storage controller 14 to stop, the screen generator 12 may resume output of the screen to the screen storage controller 14 after the screen playback part 16 delivers the screen.

Upon receiving the screen successively output from the screen generator 12, the screen storage controller 14 according to the present embodiment stores this screen in the screen storage 15. Note that the screen storage controller 14 may be configured so as to successively delete old screens that have passed the predetermined period among the screens stored in the screen storage 15. Accordingly, the screen stored in the screen storage 15 is successively updated to the screen generated in the predefined period before this timing, in which the new screen is created. Such configuration allows an action such as “storing only the screens generated in the past 10 minutes in the screen storage 15”. Accordingly, it is possible to limit the amount of data of the screen stored in the screen storage 15 and prevent depletion of the screen storage 15. Note that the “predetermined period” corresponds to a “second period.”

The screen storage controller 14 receives notification from the disconnect detection part 13 that communication with the client 2 has been interrupted. The screen storage controller 14 may be configured so as to instruct the screen generator 12 to stop the output of the screen after the predetermined period has passed upon receiving this notification. Upon receiving this instruction, the screen generator 12 stops the output of the screen to the screen storage controller 14. Accordingly, it is possible to limit the amount of data of the screen stored in the screen storage 15 and prevent depletion of the screen storage 15.

Note that if the screen storage controller 14 is run so as to successively delete old screens stored in the screen storage 15, it stops the action regarding this deletion upon receiving the notification from the disconnect detection part 13, allowing the screen storage 15 to store the screen generated in the predefined time before this timing (the second period), in which communication has been interrupted. The above configuration allows an action such as “storing screens generated within 10 minutes before the interruption of communication and the screen generated within 30 minutes after the interruption of communication in the screen storage 15”. Thus, when communication is resumed and the operator re-logs in, it is possible to confirm the screen generated within the predefined period before and after the time in which communication has been interrupted. Note that in this case, the predefined period including the previous period (the second period) and the subsequent period based on the time in which communication has been interrupted refers to the “first period”.

(Series of Actions)

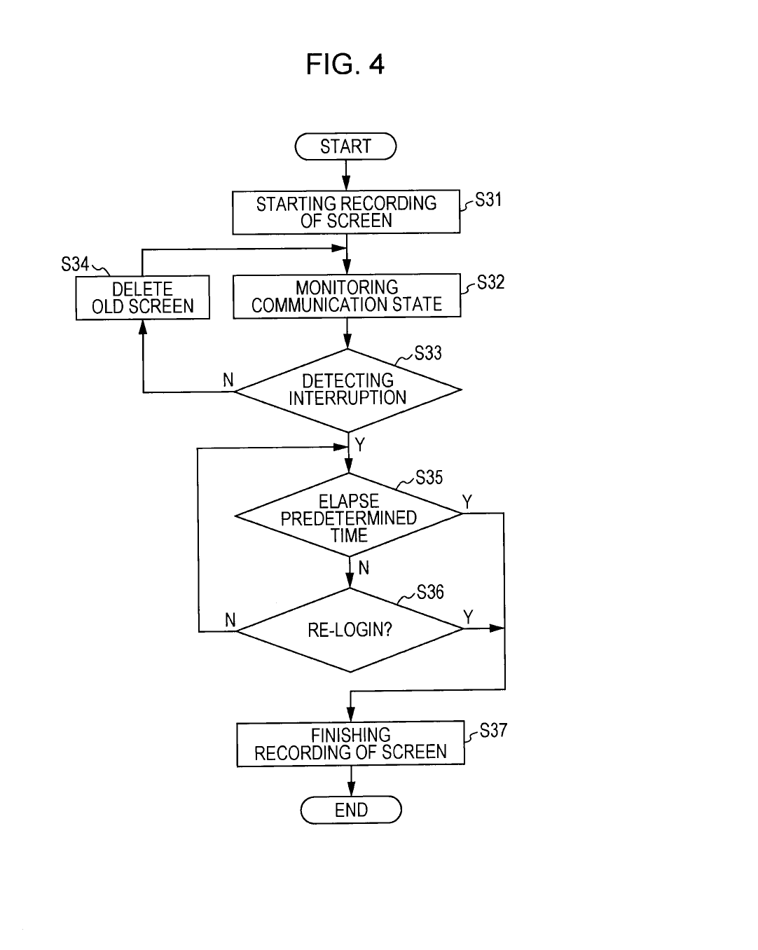

Next, the series of actions of the medical image processing system according to the present embodiment are set forth with reference to FIG. 2 and FIG. 3, focusing on differences from the medical image processing system according to the first embodiment. FIG. 4 is a flow chart of the medical image processing system according to the present embodiment showing the flow of processing regarding the detection of interruption of communication and storage of a screen to the screen storage 15. Note that the action at the time of login is similar to that for the medical image processing system according to the first embodiment.

(Step S31)

Once communication is established between the client 2 and the server 1 as the operator logs into the server 1 by means of the operation from the client 2, the screen generator 12 successively creates an operation screen and delivers this screen to the client 2. Moreover, the screen generator 12 successively outputs the created screen to the screen storage controller 14. Upon receiving the screen successively output from the screen generator 12, the screen storage controller 14 stores this screen in the screen storage 15.

(Step S32)

Moreover, the disconnect detection part 13 monitors the communication state between the client 2 and the server 1.

(Step S33, Step S34)

The disconnect detection part 13 continues to monitor this communication state while the operator is logged into the server 1 (Step S33, N). In the meantime, the screen storage controller 14 successively deletes old screens that passed the predetermined period among the screens stored in the screen storage 15 (Step S34).

(Step S33)

The disconnect detection part 13 that detects interruption of communication (Step S33, Y) notifies the screen storage controller 14 of communication interruption. The screen storage controller 14 stops the action regarding deletion of old screens upon receiving notification from the disconnect detection part 13.

(Step S35, Step S37)

If the predetermined period elapses after receiving notification from the disconnect detection part 13 (Step S35, Y), the screen storage controller 14 instructs the screen generator 12 to stop the output of the screen (Step S37). Accordingly, the screen storage controller 14 stops storing the screen in the screen storage 15.

(Step S36, Step S37)

Moreover, even before the predetermined period elapses, if the re-login to the server 1 by the operator is detected again (Step S36, Y), the output of the screen by means of the screen generator 12 is stopped. Specifically, if the screen generator 12 receives notification from the login managing part 17 that the operator has logged in while the screen is being output to the screen storage controller 14, it stops the output of the screen to the screen storage controller 14 (Step S37). Accordingly, the screen storage controller 14 stops storing the screen in the screen storage 15.

(Step S35, Step S36)

Before the predetermined period elapses (Step S35, N) and while the re-login by the operator is not detected (Step S36, N), the screen storage controller 14 stores the screen output by the screen generator 12 in the screen storage 15. Note that the action at the time of login is similar to that for the medical image processing system according to the first embodiment, including the operational aspect after the interruption of communication.

As above, the medical image processing system according to the present embodiment stores the screen generated in the predefined period before and after the interruption of communication with the client in the screen storage, making it possible to play this screen at the time of re-login. Accordingly, even if the network is disconnected and communication is interrupted, it is possible to confirm the processing results output to the screen before and after the interruption of communication.

### Third Embodiment

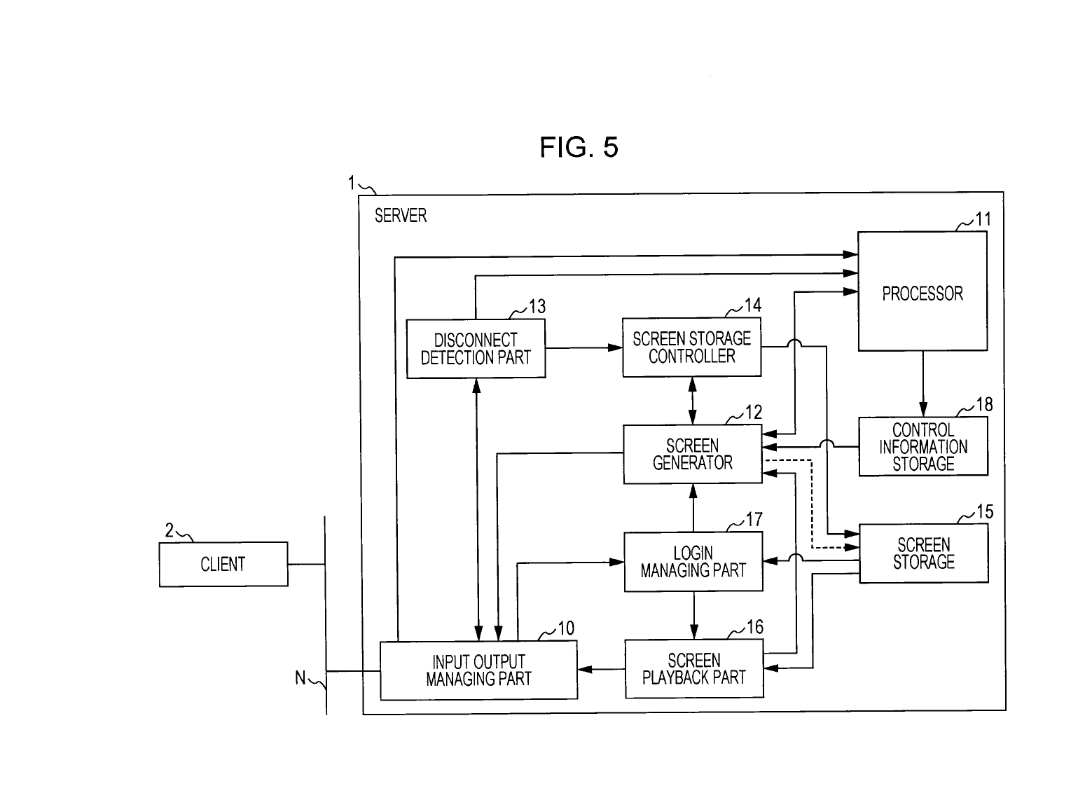

The configuration of the medical image processing system according to the third embodiment is set forth with reference to FIG. 5. The medical image processing system according to the present embodiment comprises control information storage 18 in addition to the configuration of the medical image processing system according to the first embodiment. Hereinafter, the configuration and action of the medical image processing system according to the present embodiment is set forth focusing on differences from the medical image processing system according to the first embodiment.

The disconnect detection part 13 according to the present embodiment notifies the screen storage controller 14 and the processor 11 of communication interruption when detecting the communication interruption. The action of the screen storage controller 14 receiving this notification is similar to that of the screen storage controller 14 according to the first and second embodiments.

The processor 11 according to the present embodiment receives notification from the disconnect detection part 13 that communication with the client 2 has been interrupted. Upon receiving this notification, the processor 11 stores the control information of each processing step (for example, application) running in the processor 11 in the control information storage 18. A detailed explanation will be provided subsequently regarding the control information. The control information storage 18 is storage for storing the control information.

The control information will set forth in detail here. The control information is information for reconfiguring the execution environment or the state of each application running in the processor 11. In the case of an application that generates or edits the medical image, the control information includes information showing the condition of generating and editing the medical image. A specific example of the control information includes the control parameters of each application. In this case, the processor 11 obtains the control parameters from each application running and stores the obtained control parameters in the control information storage 18 as control information. Moreover, the processor 11 may obtain information of each application deployed in the memory as image information. In this case, the processor 11 stores the obtained image information in the control information storage 18 as control information. Storing the information deployed in the memory as image information to subsequently re-deploy this image information in the memory known as a method for reconfiguring the operating environment of each application is referred to as “hibernation”.

Upon receiving notification from the login managing part 17, the screen generator 12 first confirms whether or not the control information is stored in the control information storage 18. If the control information is stored in the control information storage 18, the screen generator 12 reads the control information stored in the control information storage 18. The screen generator 12 reconfigures the operating environment of each processing step (for example, the application) in the processor 11 based on the read control information. The screen generator 12 obtains the processing results from each processing step which has reconfigured the operating environment. The screen generator 12 creates a screen based on the obtained processing results and delivers this screen to the client 2. A detailed explanation is provided below with reference to an example of the action of this screen generator 12. For example, if the control parameter of the application is stored in the control information storage 18 as control information, the screen generator 12 causes the processor 11 to activate the relevant application based on this control information. Furthermore, upon receiving the processing results of the activated application from the processor 11, the screen generator 12 creates a screen and delivers this screen to the client 2. Moreover, for example, if image information of the application is stored in the control information storage 18, the screen generator 12 reconfigures the operating environment of the relevant application in the processor 11 by re-deploying the read out image information in the memory. Furthermore, upon receiving the processing results of the activated application from the processor 11, the screen generator 12 creates a screen and delivers this screen to the client 2.

Note that if the operator logs into the server 1, the screen generator 12 may create a dialog for asking the operator whether or not to carry out reconfiguration of the screen and deliver it to the client 2. In this case, if the screen generator 12 is instructed to carry out reconfiguration of the screen by the operator, it may run so as to cause the control information storage 18 to reconfigure the screen based on the control information.

Moreover, after the screen generator 12 reads out the control information from the control information storage 18 and reconfigures the operating environment of each processing step, it may run so as to cause the control information stored in the control information storage 18 to be deleted.

Moreover, regardless of the interruption of communication, even if the operator logs out from the server 1 based on the operation from the client 2, the processor 11 may be run so as to store the control information in the control information storage 18. Accordingly, if the operator re-logs in, it is possible to display the screen of the last time logout.

(Series of Actions)

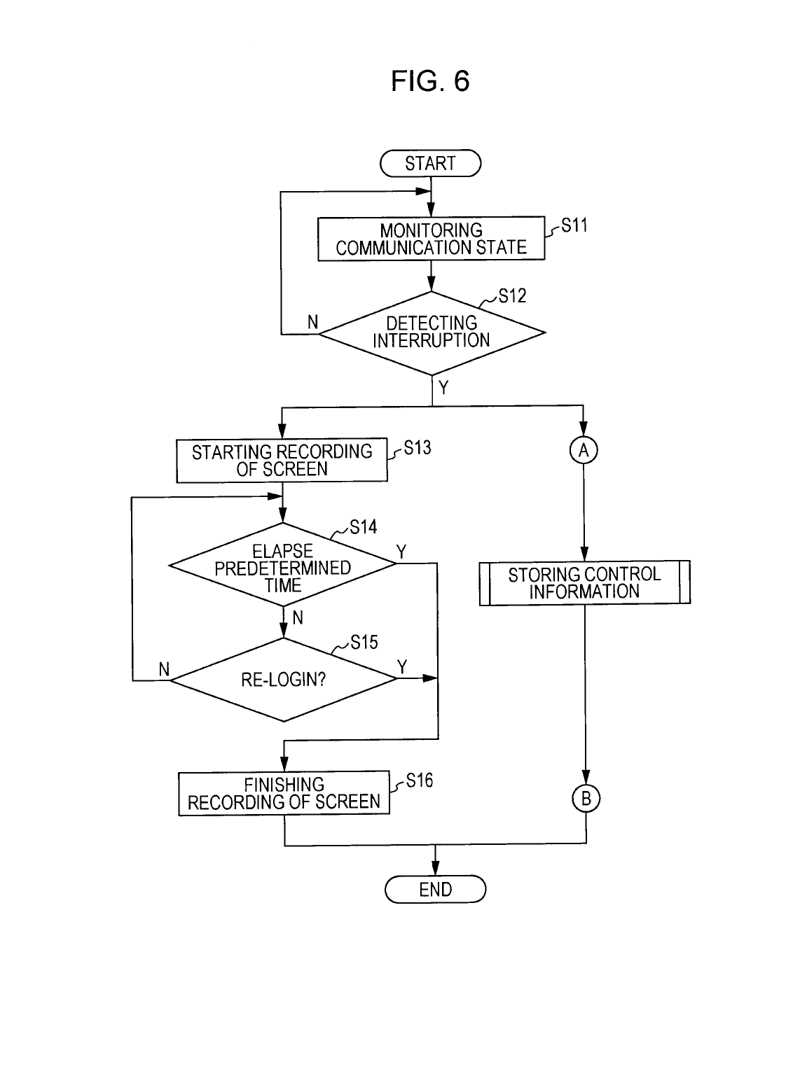

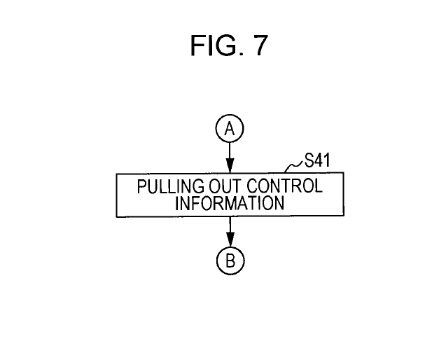

Next, the series of actions of the medical image processing system according to the present embodiment are set forth, with reference to FIG. 6 to FIG. 9. First the flow of processing related to detection of the interruption of communication and storage of the screen is set forth. FIG. 6 is a flow chart of the medical image processing system according to the present embodiment showing the flow of processing regarding detection of the interruption of communication and storage of a screen. Moreover, FIG. 7 is a flow chart showing the flow of processing regarding storage of control information. The medical image processing system according to the present embodiment is different from the medical image processing system according to the first embodiment in that upon receiving the detection of the interruption of communication, processing regarding the storage of the screen and processing regarding storage of the control information are carried out. Hereinafter, an explanation is provided focusing on differences from the medical image processing system according to the first embodiment. Note that processing regarding the detection of the interruption of communication (Step S11 in FIG. 6) and processing in which the screen is stored in the screen storage 15 upon receiving the detection of the interruption of the communication (Steps S13 to S16 in FIG. 6) are similar to the medical image processing system according to the first embodiment.

(Step S11, Step S12)

First, FIG. 6 is referenced. The disconnect detection part 13 monitors the communication state between the client 2 and the server 1 and detects when communication has been interrupted (Step S11). The disconnect detection part 13 continues to monitor this communication state while the operator continues to log in the server 1 (Step S12, N). If the disconnect detection part 13 detects that communication has been interrupted (Step S12, Y), it notifies the screen storage controller 14 and the processor 11 that communication has been interrupted.

(Step S41)

Here, FIG. 7 is referenced. The processor 11 receives notification from the disconnect detection part 13 that communication with the client 2 has been interrupted. Upon receiving this notification, the processor 11 causes the control information storage 18 to store the control information of each processing step that runs in the processor 11.

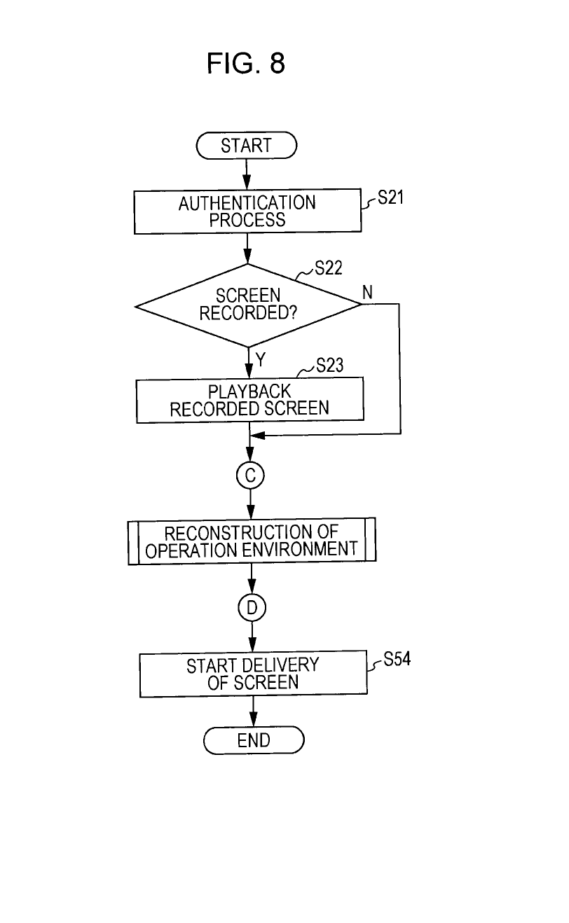

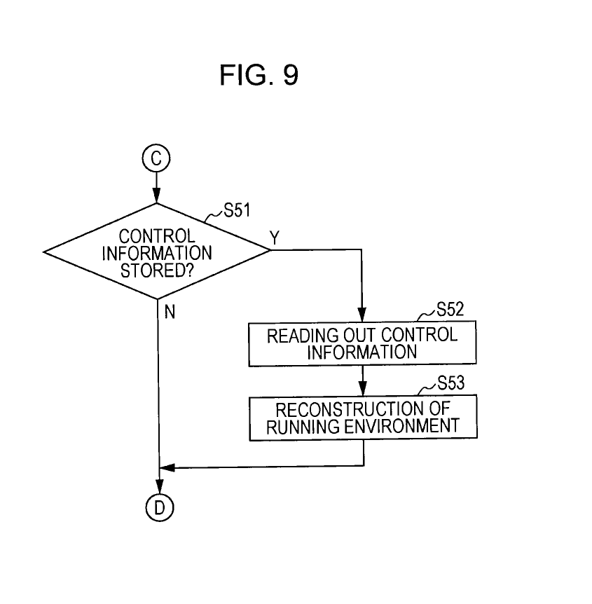

Next, an explanation is provided focusing on a series of actions at the time of login, particularly focusing on the action when communication has been interrupted, with reference to FIG. 8 and FIG. 9. FIG. 8 is a flow chart showing the action at the time of login for the medical image processing system according to the present embodiment. FIG. 9 is a flow chart showing the flow of processing regarding the reconfiguration of the operating environment. The medical image processing system according to the present embodiment is different from the medical image processing system according to the first embodiment in that if the control information is stored in the control information storage 18 when the operator logs in, the operating environment of the application is reconfigured based on this control information. Hereinafter, an explanation is provided focusing on differences from the medical image processing system according to the first embodiment. Note that authentication processing (Step S21 in FIG. 8) and processing regarding playback of the screen (Step S22 and S23 in FIG. 8) are similar to the medical image processing system according to the first embodiment.

(Step S51)

First, FIG. 9 is referenced. When processing by means of the screen playback part 16 is completed, the screen generator 12 first confirms whether or not the control information is stored in the control information storage 18.

(Step S52)

If the control information is stored in the control information storage 18 (Step S51, Y), the screen generator 12 reads out the control information stored in the control information storage 18.

(Step S53)

The screen generator 12 reconfigures the operating environment of each processing step (for example, application) in the processor 11 based on the read control information.

(Step S54)

Here, FIG. 8 is referenced. The screen generator 12 obtains the processing results from each processing step in which the operating environment has been reconfigured. The screen generator 12 creates a screen based on the obtained processing results and delivers this screen to the client 2. Note that if the control information is not stored in the control information storage 18 (Step S51, N in FIG. 9), the screen generator 12 newly creates the operation screen without carrying out processing regarding the reconfiguration of the operating environment (Step S52, S53 in FIG. 9) and delivers this screen to the client 2. Hereinafter, the screen generator 12 successively creates an operation screen and delivers the screen to the client 2.

As above, in addition to the similar effect of the first and the second embodiments, the medical image processing system according to the present embodiment allows the operating environment of the application for cases in which communication is interrupted to be reconfigured. Accordingly, the operator can promptly continue work interrupted due to the interruption of the network, after re-logging in.

### Fourth Embodiment

Upon receiving the interruption of communication, the medical image processing system according to the third embodiment allows the control information storage 18 to store the control information of each processing step running in the processor 11 regardless of the status of each processing step. If the processing step running in the processor 11 is present when communication has been interrupted, the medical image processing system according to the present embodiment monitors this processing, and if this processing is completed or reaches hibernation, it stores the control information in the control information storage 18. Hereinafter, the configuration and action of the medical image processing system according to the present embodiment are set forth focusing on differences with the medical image processing system according to the third embodiment.

The processor 11 receives notification from the disconnect detection part 13 that communication with the client 2 has been interrupted. Upon receiving this notification, the processor 11 monitors the state of the processing step that is running (for example, application). For example, as the method for the processor 11 to monitor the processing step that is running, it may obtain from an OS (Operating System) a list of processes that are running, specify from this list the application that the processor 11 is causing to run, and obtain the state of the specified application. If the processing step that is running is completed, or if the processing step that is running reaches hibernation, the processor 11 causes the control information storage 18 to store the control information of processing thereof. Note that regarding all processing steps that have been running, if storing of the control information in the control information storage 18 is completed, the processor 11 finishes monitoring processing.

If the operator logs into the server 1, the processor 11 is requested by the screen generator 12 to notify the monitoring status. When continuing monitoring the processing, the processor 11 notifies the screen generator 12 that processing is being monitored. Alternatively, when not monitoring the processing, the processor 11 notifies the screen generator 12 accordingly.

Moreover, if the processor 11 notifies the screen generator 12 that processing is being monitored, it is subsequently requested by the screen generator 12 to notify of the processing step that is running. Upon receiving this request, the processor 11 notifies the screen generator 12 of identification information for specifying the processing step that is running. Examples of this identification information may be process ID of application, etc. Accordingly, the screen generator 12 can specify the processing step that is running in the processor 11 and obtain the processing results thereof. An explanation will be provided subsequently regarding specific actions of the screen generator 12 in this case. If the processor 11 receives this request when it is not monitoring processing, it does not carry out output of the identification information to the screen generator 12.

Upon receiving notification from the login managing part 17, the screen generator 12 requests the processor 11 to notify the monitoring status of processing. Based on this notification, the screen generator 12 confirms whether or not the processor 11 is continuing to monitor processing. If the processor 11 is continuing to monitor processing, the screen generator 12 requests the processor 11 notification of the processing step that is running. In response to this request, the screen generator 12 receives from the processor 11 the identification information for specifying the processing step that is running. The screen generator 12 specifies the processing step that is running in the processor 11 based on this identification information, and thereafter, it obtains the processing results from this specified processing. Note that if the processor 11 is not monitoring processing, the screen generator 12 moves to the next processing step without requesting notification of the processing step that is running.

Next, the screen generator 12 confirms whether or not the control information is stored in the control information storage 18. If the control information is stored, the screen generator 12 reads this control information from the control information storage 18. The screen generator 12 reconfigures the operating environment of each processing step (for example, application) in the processor 11 based on the read control information. The screen generator 12 obtains the processing results from each processing step in which the operating environment has been reconfigured.

The screen generator 12 creates a screen based on the processing results obtained from the processing step that is running and the processing results obtained from processing in which the operating environment is reconfigured based on the control information, and delivers this screen to the client 2.

Note that the screen generator 12 may cause the processor 11 to run so as to request the output of the control information, instead of requesting notification of the processing step that is running. In this case, the processor 11 obtains the control information of the processing step that is running. The processor 11 outputs the obtained control information to the screen generator 12. The screen generator 12 reconfigures the operating environment of the running processing step in the processor 11 based on this control information. Note that if the screen generator 12 reconfigures the operating environment of the running processing step in the processor 11, it may run so as to stop this processing that has been running in the processor 11 and subsequently reconfigure the operating environment of each processing step.

(Series of Actions)

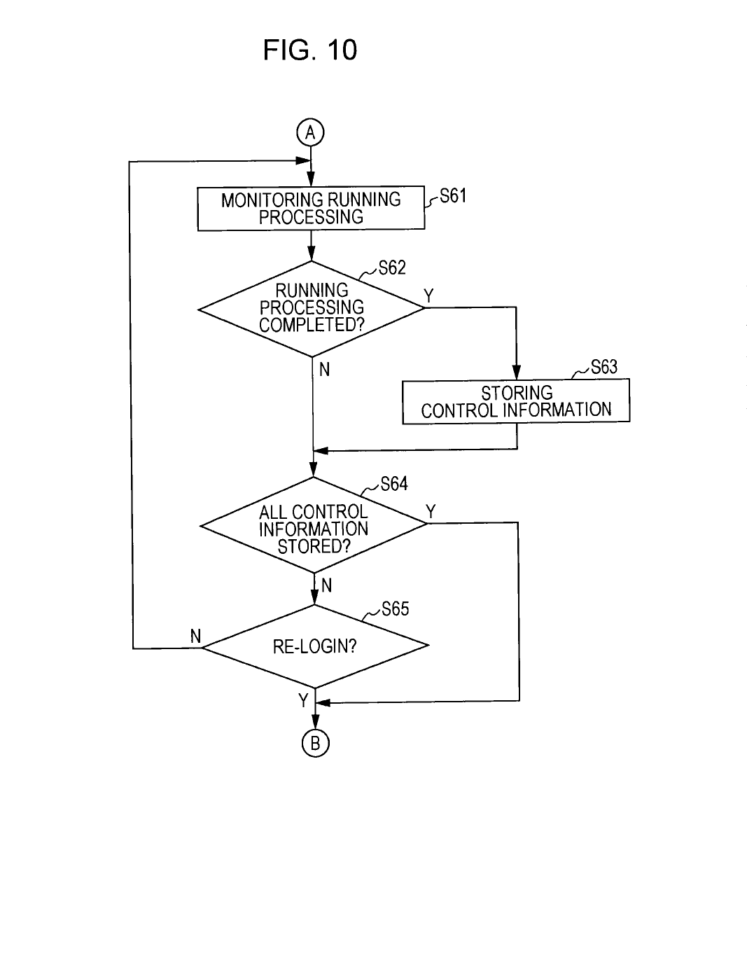

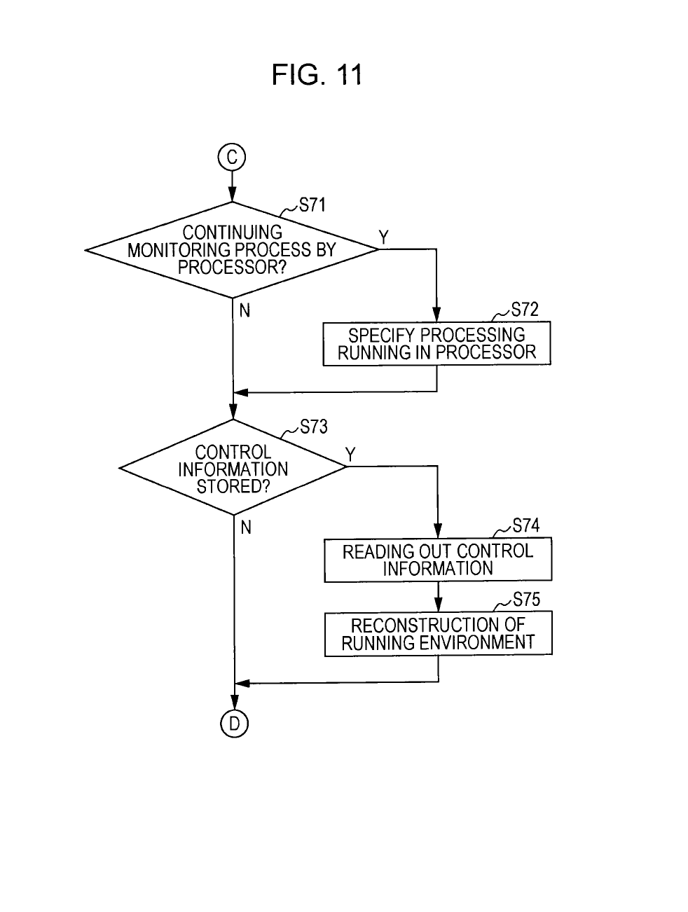

Next, a series of actions of the medical image processing system according to the present embodiment are set forth, with reference to FIG. 6, FIG. 8, FIG. 10, and FIG. 11. First, with reference to FIG. 6 and FIG. 10, the flow of processing for the detection of interruption of communication and storage of the screen is set forth. FIG. 6 is a flow chart of the medical image processing system according to the present embodiment showing the flow of processing regarding the detection of interruption of communication and storage of a screen to the screen storage 15. FIG. 10 is a flow chart showing the flow of processing regarding storage of control information. Hereinafter, an explanation is provided by focusing on differences from the medical image processing system according to the third embodiment. Note that each processing step (S11 to S16) shown in FIG. 6 is similar to the medical image processing system according to the third embodiment.

(Step S11, Step S12)

First, FIG. 6 is referenced. The disconnect detection part 13 monitors the communication state between the client 2 and the server 1 and detects when communication is interrupted (Step S11). The disconnect detection part 13 continues monitoring this communication state while the operator is logged into the server 1 (Step S12, N). If the disconnect detection part 13 detects that communication has been interrupted (Step S12, Y), it notifies the screen storage controller 14 and the processor 11 that communication has been interrupted.

(Step S61)

Here, FIG. 10 is referenced. The processor 11 receives notification from the disconnect detection part 13 that communication with the client 2 has been interrupted. Upon receiving this notification, the processor 11 monitors the state of the running processing step (for example, application).

(Step S62, Step S63)

If the running processing step is completed, or if the running processing step reaches hibernation (Step S62, Y), the processor 11 stores the control information of processing thereof in the control information storage 18. If the processor 11 continues the action without processing being completed or stopped (Step S62, N), the processor 11 moves to the next processing step without carrying out processing regarding storage of the control information.

(Step S64)

Regarding all processing that has been running in the processor 11, if storing the control information in the control information storage 18 is completed (Step S64, Y), the processor 11 finishes monitoring processing.

(Step S65)

If the operator logs into the server 1 (Step S65, Y), the screen generator 12 requests the processor 11 to notify the monitoring status of processing. Accordingly, the screen generator 12 confirms that the processor 11 is continuing to monitor processing. Subsequent actions are set forth along with the action at the time of login. If storing the control information in the control information storage 18 is not completed regarding all processing, the processor 11 continues monitoring the state of the running processing step (Step S64, N, and Step S65, N).

Next, an explanation is provided with reference to FIG. 9 and FIG. 11 by focusing on a series of actions at the time of login, particularly the action when communication is interrupted. FIG. 8 is a flow chart showing the action at the time of login for the medical image processing system according to the present embodiment. FIG. 11 is a flow chart showing the flow of processing regarding reconfiguration of the operating environment. Hereinafter, an explanation is provided focusing on differences from the medical image processing system according to the third embodiment. Note that each processing step (S21 to S23, and S54) shown in FIG. 8 is similar to the medical image processing system according to the third embodiment.

(Step S71, Step S72)

First, FIG. 11 is referenced. If processing by means of the screen playback part 16 is completed, the screen generator 12 first requests the processor 11 to notify the monitoring status of processing. Based on this notification, the screen generator 12 confirms whether or not the processor 11 is continuing to monitor processing. If the processor 11 is continuing to monitor processing (Step S71, Y), the screen generator 12 requests the processor 11 to notify of the processing step that is running. As a response to this request, the screen generator 12 receives the identification information for specifying the processing step that is running from the processor 11. The screen generator 12 specifies processing that has been running in the processor 11 based on this identification information and obtains the processing results from this processing thereafter. If the processor 11 is not monitoring processing (Step S71, N), the screen generator 12 moves to the next processing step without requesting notification of the processing step that is running.

(Step S73)

Next, the screen generator 12 confirms whether or not the control information is stored in the control information storage 18.

(Step S74)

If the control information is stored (Step S73, Y), the screen generator 12 reads this control information from the control information storage 18.

(Step S75)

The screen generator 12 reconfigures the operating environment of each processing step (for example, application) in the processor 11 based on the read out control information. The screen generator 12 obtains the processing results from each processing step in which the operating environment has been reconfigured.

Note that if the control information is not stored in the control information storage 18 (Step S73, N), the screen generator 12 does not carry out processing regarding the reconfiguration of the operating environment (Step S74, S75).

(Step S54)

Here, FIG. 8 is referenced. The screen generator 12 creates a screen based on the processing results obtained from the running processing step as well as the processing results obtained from processing in which the operating environment is reconfigured based on the control information, and delivers this screen to the client 2. An operation screen is created and delivered to the client 2. Hereinafter, the screen generator 12 successively creates an operation screen, which is delivered to the client 2.

As above, if the running processing step remains, the medical image processing system according to the present embodiment allows the control information storage 18 to store the control information, after this processing reaches hibernation or finishes. Accordingly, it is possible to prevent interrupting the processing step running in the processor 11 accompanied with obtaining the control information. Moreover, it is no longer necessary to carry out processing regarding storage of the control information with respect to all processing, making it possible to reduce the burden of processing in terms of storage of the control information.

Some embodiments are set forth; however, these embodiments provide examples and are not intended to limit the scope of the invention. It is possible to carry out these novel embodiments in various other forms of embodiments, making it possible to allow for various omissions, replacements, and changes without departing from the scope of the invention. These embodiments and variations thereof are included in the scope and spirit of the invention and are also included in the equivalent scope described in the scope of the claims.

### EXPLANATION OF THE SYMBOLS

1 Server
10 Input Output managing part
11 Processor
12 Screen generator
13 Disconnect detection part
14 Screen storage controller
15 Screen storage
16 Screen playback part
17 Login managing part
18 Control information storage
2 Client

What is claimed is:

1. A medical image processing system including a server, comprising a processor configured to execute an application for generating or editing medical images based on instructions from a client; and a screen generator configured to generate a screen upon receiving the processing results of the application to deliver the generated screen to the client, the server comprising:
a disconnect detector configured to detect interruption of communication with the client;
a screen storage;
a screen storage controller configured to store the screen generated in a first period in the screen storage based on a timing in which the disconnect detector detects interruption of communication with the client; and
a screen playback part configured to deliver the screen stored in the screen storage to the client.

2. The medical image processing system according to claim 1, wherein the first period is a period after the time of the detection by means of the disconnect detector.

3. The medical image processing system according to claim 1, wherein the first period is a period comprising the time of the detection by means of the disconnect detector and a period before and after the timing.

4. The medical image processing system according to claim 3, wherein the screen storage controller is configured to update the screen stored in the screen storage such that the screen storage stores the screen of a second period before the timing of generating the screen, among the screen generated based on the instructions from the client, and to stop the update when detection of the disconnect detector is received, and
the first period comprises the second period before the time of the detection by the disconnect detector.

5. The medical image processing system according to claim 1, comprising a login detection part configured to detect when an operator has logged into the server by means of an operation from the client,
wherein the screen playback part is configured to deliver the screen stored in the screen storage to the client when the login detection part detects the login after the interruption of the communication.

6. The medical image processing system according to claim 5, comprising
a control information storage,
wherein upon receiving the detection by means of the disconnect detector, the processor is configured to cause the control information storage to store control information comprising at least a condition of generation and editing of the medical image for reconfiguring the operating environment of the application after the interruption of the communication and
when the login detection part detects the login after the interruption of the communication, the screen generator is configured to generate a screen upon receiving the processing results of the processor and to deliver the screen to the client upon reconfiguring the operating environment of the application, based on the control information stored in the control information storage.

7. The medical image processing system according to claim 6, wherein, upon receiving the detection by means of the disconnect detector, the processor is configured to monitor the running application, and to cause the control information storage to store the control information after processing of the application is completed, and
if the running application is present, the screen generator is configured to obtain the processing results from the application, and if the control information is stored in the control information storage, the screen generator is configured to reconfigure the operating environment of the corresponding application based on the control information stored in the control information storage; to obtain the processing results of the application; to generate the screen based on the obtained processing results; and to deliver the generated screen to the client.

8. The medical image processing system according to claim 6, wherein the screen generator is configured to reconfigure the operating environment of the application after the screen playback part delivers the screen stored in the screen storage.

9. A medical image processing server, comprising a processor that executes an application for generating or editing a medical image based on instructions from a client, and a screen generator configured to generate a screen upon receiving the processing results of the application and to deliver the generated screen to the client; the medical image processor server comprising:
a disconnect detector configured to detect when communication with the client has been interrupted;
a screen storage;
a screen storage controller configured to cause the screen storage to store the screen generated in a first period from the time when the disconnect detector detects interruption of communication with the client; and
a screen playback part is configured to deliver the screen stored in the screen storage to the client.

10. A medical image processing system including a server, comprising a processor that executes an application for generating or editing a medical image based on instructions from a client, and a screen generator configured to generate a screen upon receiving the processing results of the application and to deliver the generated screen to the client; the server comprising:
a disconnect detector configured to detect when communication with the client has been interrupted;
a screen storage;
a screen storage controller is configured to cause the screen storage to store the generated screen;
a login detection part configured to detect when an operator has logged into the server by an operation from the client; and
the screen playback part configured to deliver the screen stored in the screen storage to the client when the login detection part detects the login after the interruption of the communication.
